(19) United States
(12) Patent Application Publication
(10) Pub. No.: US 2019/0132420 A1
(43) Pub. Date: May 2, 2019

(54) TEMPORAL PINNING OF AN ENTITY TO A DATA CENTER

(71) Applicant: Microsoft Technology Licensing, LLC, Redmond, WA (US)

(72) Inventors: Yellamraju Venkata Srinivas, Cupertino, CA (US); Jianhong Fang, Milpitas, CA (US); Pak Hi Randy Ho, San Jose, CA (US); Qi Liu, Saratoga, CA (US)

(21) Appl. No.: 15/798,076

(22) Filed: Oct. 30, 2017

(51) Int. Cl. H04L 29/08

(52) U.S. Cl. CPC H04L 67/327; G06Q 50/01; H04L 67/101; H04L 67/325

(57) ABSTRACT

A machine may be configured to pin data associated with an entity to a data center for a period of time. For example, the machine receives a request to initiate an operation that uses data associated with an entity. The machine, based on the request to initiate the operation, pins the entity to a first data center of the plurality of data centers for a period of time. The pinning results in a suspension of a scheduled routing of data requests associated with the entity to a second data center of the plurality of data centers. The machine determines a status of the operation that uses the data associated with the entity. The machine, based on a determination that the operation is completed, updates data pertaining to the scheduled routing in a routing record that associates the entity with the second data center of the plurality of data centers.

### TECHNICAL FIELD

The present application relates generally to systems, methods, and computer program products for pinning the data associated with an entity to a data center for a period of time.

### BACKGROUND

Companies that provide content or services online may sometimes need to redirect online traffic from one data center to another data center. A data center may be a group of networked computer servers typically used by organizations for storage, processing, or distribution of large volumes of data. The reasons for data redirection may be many: load-balancing, system maintenance, minimizing latency in servicing requests for data, etc.

### BRIEF DESCRIPTION OF THE DRAWINGS

Some embodiments are illustrated by way of example and not limitation in the figures of the accompanying drawings, in which:

FIG. 1A is a diagram illustrating networked data centers associated with a pinning system, according to some example embodiments;

FIG. 1B is a network diagram illustrating a client-server system, according to some example embodiments;

FIG. 2 is a block diagram illustrating components of a pinning system, according to some example embodiments;

FIG. 3 is a flowchart illustrating a method for pinning the data associated with an entity to a data center for a period of time, according to some example embodiments;

FIG. 4 is a flowchart illustrating a method for pinning the data associated with an entity to a data center for a period of time, and representing an additional step of the method illustrated in FIG. 3, according to some example embodiments;

FIG. 5 is a flowchart illustrating a method for pinning the data associated with an entity to a data center for a period of time, and representing step 306 of the method illustrated in FIG. 3 in more detail, according to some example embodiments;

FIG. 6 is a flowchart illustrating a method for pinning the data associated with an entity to a data center for a period of time, and representing step 304 of the method illustrated in FIG. 3 in more detail, according to some example embodiments;

FIG. 7 is a flowchart illustrating a method for pinning the data associated with an entity to a data center for a period of time, and representing step 306 of the method illustrated in FIG. 3 in more detail, according to some example embodiments;

FIG. 8 is a flowchart illustrating a method for pinning the data associated with an entity to a data center for a period of time, and representing step 306 of the method illustrated in FIG. 3 in more detail, and an additional step of the method illustrated in FIG. 3, according to some example embodiments; and

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems for pinning the data associated with an entity to a data center for a period of time, are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Often, companies that provide online content or services employ a distributed system that serves data from different data centers. Traditionally, a distributed system that serves data from different data centers routes online traffic according to a user identifier (e.g., a user ID) associated with a user requesting access to certain data. For example, a consumer-facing website, such as a LinkedIn® login page, facilitates the logging in of a user based on the user's login credentials. The user may be a member of the professional online social network service (SNS) provided by LinkedIn®. A backend system may determine, based on the user's login credentials, that the user's request to access his profile page should be redirected to a particular data center (e.g., a London, UK data center, or a San Jose, Calif. data center).

A company, such as LinkedIn®, in addition to having members of the SNS as customers, may also have enterprise customers, such as various organizations or companies, to which it provides professional services. Examples of such professional services are recruiter services, sales services, advertising services, educational services, etc.

In some example embodiments, the distributed system that serves data from different data centers routes online traffic based on an entity identifier (ID) rather than a user ID. An entity may include an account or a contract. An account may be an organization or a company, or several organizations or companies grouped together (e.g., a parent company and a subsidiary company). Examples of an account may be “Google,” “Alphabet” (e.g., the parent company of Google), or “YouTube” (e.g., a subsidiary of Google). A contract may represent a particular agreement between the service-delivering company and an account that specifies a particular service to be delivered, or particular terms of agreement. In some instances, an account may be associated with several contracts.

In certain example embodiments, a user's request for data is redirected to a particular data center based on a geographic location of the user. For example, the system determines that a large number (e.g., a majority) of requests for data associated with an entity (or with an entity and a service) are received from a certain geographic area (e.g., from Europe). Based on the origin of the data access requests associated with the entity (or with the entity and service), a particular data center may be designated as the location from which to service the data access requests associated with the entity (or with the entity and service). In this example, a data center on the East Coast of the U.S. is designated to service the requests for data associated with the entity (or with the entity and service) based on the fact that the large number of data access requests associated with the entity (or with the entity and service) are received from Europe.

The designation of a particular data center as being the location from which to service requests for data associated with the entity (or with the entity and the service) may be made in a record of a database that pertains to managing access to the data associated with the entity (or with the entity and the service). The database record may be associated with the entity. The database record may include a data center identifier of the particular data center designated as the location from which to serve requests for data associated with the entity (or with the entity and the service), and an effective time representing a time to start servicing the requests for data associated with the entity (or with the entity and the service). The system may access the database record to determine to which data center to redirect a data access request associated with the entity.

In various example embodiments, online traffic associated with a particular entity may be scheduled to be redirected from a first data center to a second data center. For example, a route scheduling service schedules a redirection of data requests (e.g., read requests, write requests, or both) associated with the “Google” contract from a first data center to a second data center to become effective at 10:00 p.m. on Oct. 1, 2017, PDT. A user may engage in one or more online operations using data related to the “Google” contract, such as providing a payment for a service, close in time to the effective time of the online traffic redirection between the two data centers. Accordingly, it may be desirable to have a mechanism for improving data consistency during a shift of traffic between the two data centers while avoiding down time in order to facilitate the completion of the online operations by the user. The process of pinning certain data records to a particular data center for a period of time enhances a system for managing network traffic shifting between multiple data centers by improving data consistency between the multiple data centers.

According to various example embodiments, a pinning system (hereinafter also “system”) pins certain data records at a database of a data center for a period of time in order to allow the completion of one or more online operations that may utilize the certain data records. In some instances, the data records that are being pinned are associated with the entity and with a particular service. The particular service may include the one or more operations that utilize the certain data records. As a result of the pinning, a scheduled routing of data requests associated with a particular entity to a second data center of the plurality of data centers are temporarily suspended, and the data requests associated with the particular entity (or with the particular entity and the particular service) continue to be routed to the first data center.

For example, a user of LinkedIn® is employed by Google as a recruiter. Google may be an enterprise client of LinkedIn®, and as such may be identified as an “entity” by a computer system associated with LinkedIn®. The user may login into LinkedIn®, and may request access to a Recruiter service (e.g., a Recruiter application) provided by to LinkedIn® to Google based on a contract between LinkedIn® and Google. If the data associated with the entity (e.g., Google) and with the service (e.g., e.g., Recruiter service) is being used in an operation included in the service (e.g., the recruiter is making a payment for the service), the data associated with the entity, the service, or both is pinned to a designated first data center for a period of time (e.g., a pinning period). As a result, additional requests for the data associated with the entity, the service, or both will continue to be serviced from the first data center even though there may be a prior scheduled event for redirection of the data requests associated with the entity, the service, or both to a second data center.

In certain example embodiments, the pinning system maintains the pinning of the data associated with the entity (or with the entity and a service) to the first data center until the entity-related data is replicated to the second data center. After the pinning period expires (e.g., the pinning is terminated), data access requests for the data associated with the entity, the service, or both may be serviced, by the system, from the second data center by redirecting the data access requests to the second data center.

According to some example embodiments, the determination whether to pin the data records associated with an entity to the first data center is based on the type of service the client device of a user attempts to access. For example, if the Google recruiter, in the example above, is attempting to use a payment service, the computer system causes a pinning of the data records associated with Google and the payment service to the first data center. This may allow the Google recruiter to continue to use the payment service without a risk of loss of data or of data inconsistency.

The computer system may perform the pinning of the data to the first data center based on receiving, at a server, a request to initiate an operation that uses data associated with the entity. The request may be received from a client device associated with a user (e.g., a member of the SNS). The data associated with the entity may be stored at least in part at one or more data centers of the plurality of data centers. The pinning results in the data requests associated with the particular entity being serviced at the first data center. Based on a determination that the operation that uses data associated with the particular entity is completed, the computer system may terminate the pinning of the data associated with the particular entity to the first data center. The computer system may update a record that identifies (e.g., stores) a routing schedule that indicates that data requests associated with the particular entity should be redirected to (e.g., serviced at) the second data center. For example, the computer system may update an effective time of the redirection of data requests associated with the particular entity in the record that identifies the routing schedule.

In some instances, the effective time also indicates a time when the pinning of data associated with the entity (or with the entity and the service) is lifted (e.g., terminated). In various example embodiments, a progress of the operation is being monitored (e.g., by a service) to determine whether the operation is completed, and the effective time is dynamically adjusted based on the operation being completed. In some instances, the effective time may be dynamically adjusted from a pre-determined (e.g., default) time to an actual current time corresponding to the time when the operation is completed, or to the time the completion of the operation is identified. The pinning system dynamically adjusts the period of time based on a monitoring of a completion of the operation that uses the data associated with the particular entity. The pinning system causes a termination of the pinning based on the dynamically adjusted period of time. Example benefits of such adaptive pinnings are faster traffic redirections and more efficient data replications between machines at various data centers.

According to some example embodiments, the pinning system accesses a database record (e.g., a routing record) associated with an entity ID to determine whether it can serve the data requests associated with the entity at a current time, and from which data center. For example, a database record associated with an entity ID (e.g., Entity 123) includes a first entry that states: “For Entity 123, serve all data request from the Oregon data center, starting at Oct. 1, 2016, 10:00 am.” “Entity 123” may represent an account, a contract, etc. The first entry indicates the original data center (e.g., the Oregon data center) from which data requests for this entity are serviced.

The database record associated with the entity ID may include a second entry that designates a different data center (e.g., a Virginia data center) to service data requested for this entity. A second data center may be designated as a location from which to service the data requests for the entity for various reasons, such as, the first data center is overloaded, to speed up the servicing of the data requests, the second data center is geographically closer to the origin of the data requests, the first data center is undergoing maintenance, etc.

The second entry of the record may state that the requests for the data pertaining to Entity 123, will be redirected to (e.g., serviced from) the Virginia data center, starting on Oct. 20, 2016, at “2:00 pm+10 min.” The time “2:00 pm+10 min” may indicate the effective time at which to start servicing data requests from the Virginia data center. The time “2:00 pm” may indicate the start time of the data replication of the entry-related data from the Oregon data center to the Virginia data center.

In some example embodiments, if a data request for the data pertaining to Entity 123 is received by the pinning system at 01:57 pm, the pinning system may determine the type of the received data request, and, based on the type of the received data request, may pin Entity 123 to the first data center (e.g., the Oregon data center). The pinning may include adding an entry that associates Entity 123 with an identifier of the first data center for a period of time in a pin bucket (e.g., a further record of the database) associated with the first data center. The pin bucket stores one or more entries that associate one or more entities with the identifier of the first data center for periods of time corresponding to the times the one or more entities are pinned to the first data center to allow various online operations that use the data associated with the one or more entities to be completed.

To continue the example above, the period of time “10 min” may be a default period of time selected for a pinning to allow one or more operations using the data related to the Entity 123 to be completed. This default period of time may be, in some instances, adjusted dynamically based on a received signal that indicates that the one or more operations are completed.

In certain example embodiments, the pinning system queries an operation monitoring service with respect to whether an online operation that uses the data associated with the entity is completed. For example, at 2:00 pm, a request to initiate the online operation is received from a client device. The pinning system pins the data to the first data center for a period of time (e.g., a pinning period). After the pinning period starts, the pinning system may generate queries that regard the completion of the online operation and that are directed to the operation monitoring service at certain intervals of time. At 2:01 pm, the pinning system queries the operation monitoring service regarding a completion of the operation that uses the data pertaining to the entity. If the operation is not complete, the operation monitoring service will reply to the query and indicate in the query reply that the operation is not yet complete. At 2:02 pm and/or at 2:03 pm, the pinning system may generate other queries directed to the operation monitoring service. When the operation is completed, and the query reply indicates that the operation is completed, the pinning system updates the database record associated with the entry to indicate that the effective time for starting to service data requests from the second data center corresponds to the current time (e.g., the time when the query reply is received by the pinning system). This indicates that the pinning is terminated, and that the data requests may be serviced from the second data center.

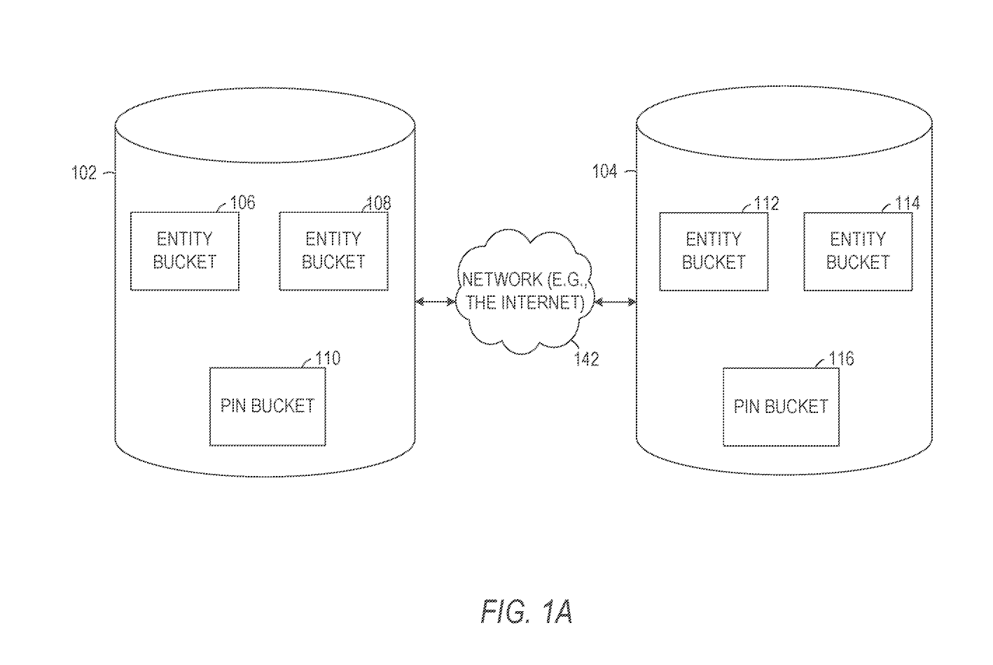

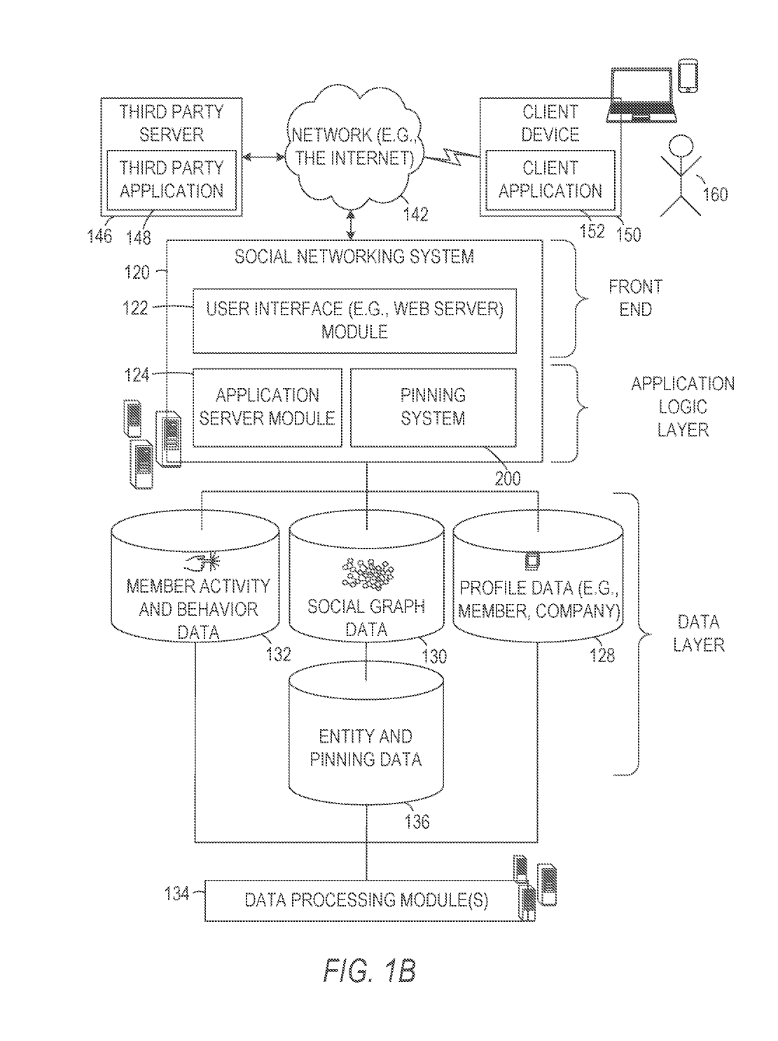

FIG. 1A is a diagram illustrating networked data centers associated with a pinning system, according to some example embodiments. As shown in FIG. 1A, the pinning system is associated with a plurality of data centers, such as a first data center, data center 102, and a second data center, data center 104. Data center 102 and data center 104 store various data associated with one or more entities. Both data center 102 and data center 104 may be active (e.g., data may be read from records stored there, and data may be written to the records). Data may be transmitted (e.g., replicated) between data center 102 and data center 104 via a network 142. The availability of multiple active data centers may provide redundancy and scalability of data.

In some example embodiments, a data center includes one or more entity buckets (e.g., records in a database). As shown in FIG. 1A, data center 102 includes entity bucket 106 and entity bucket 108, and data center 104 includes entity bucket 112 and entity bucket 114. Identifiers of one or more entities may be associated with (e.g., assigned to, included in, etc.) a particular entity bucket at a data center. The data associated with an entity may or may not be stored in an entity bucket.

In various example embodiments, entity buckets are groups of entities. The grouping of entities may be performed for efficient management of data. Entities belong to entity buckets, and certain entity buckets are mapped to certain data centers. In some instances, the number of entity buckets is small (e.g., one hundred). When network traffic (e.g., data requests) needs to be shifted from one data center to another, entity buckets are remapped from one data center to another data center. Because remapping each individual entity from one data center to another data center would take a very long time, remapping entity buckets from one data center to another data center is a more efficient method of shifting traffic from one data center to another data center.

According to various example embodiments, the assignment of entities to entity buckets is random. As new entities are created, they are assigned to the available entity buckets in sequence (e.g., round robin method). As a result, each entity bucket has roughly the same number of entities. For example, if there are three entity buckets, entity bucket 1, entity bucket 2, and entity bucket 3, and five entities A, B, C, D, and E, entity A is assigned to entity bucket 1, entity B is assigned to entity bucket 2, entity C is assigned to entity bucket 3, entity D is assigned to entity bucket 1, and entity E is assigned to entity bucket 2.

In some instances, instead of remapping individual entities from one data center to another data center one-by-one, a first entity bucket at a first data center is remapped to a second entity bucket at a second data center at one time. For example, Entity 123 is assigned to entity bucket 106 of data center 102. Entity 456 is also assigned to entity bucket 106 of data center 102. Entity 789 is assigned to entity bucket 108 of data center 102. Entity 101 is assigned to entity bucket 114 of data center 104. At an effective rerouting time associated with entity bucket 106, entity bucket 106 of data center 102 is remapped to entity bucket 112 of data center 104. As a result of this remapping, a database record is updated to indicate that Entity 123 and Entity 456 are assigned to bucket 112 of data center 104, and that data requests associated with Entity 123 or Entity 456 should be serviced from data center 104 at a particular effective time.

Each of the data centers associated with the pinning system includes a pin bucket for identifying entities that are temporarily pinned to a respective data center. As shown in FIG. 1A, data center 102 includes pin bucket 110, and data center 104 includes pin bucket 116. An entry may be added to a pin bucket of a first data center to indicate that the data associated with a particular entity (or an entity and a service) is being used during an online operation, and that, for a period of time that covers the duration of the pinning, data requests for the data associated with the particular entity should continue to be serviced from the first data center.

In some example embodiments, a replication of the data associated with entity bucket 106 is scheduled for a particular effective replication time. The pinning system receives a request to initiate an online operation that uses data associated with an entity assigned to bucket 106. The pinning system compares the time associated with the request to initiate the operation, and the particular effective replication time, and determines that the time associated with the request is within a pre-defined time limitation (e.g., 10 minutes before the particular effective replication time). In some instances, the pre-defined time limitation is provided by an administrator of the pinning system to indicate that if an operation that uses data associated with an entity is initiated during the pre-defined time limitation, the pinning system should pin the entity to the pin bucket associated with the respective data center for a period of time (e.g., the duration of the pinning). If the operation that uses data associated with the entity is initiated before the pre-defined time limitation, the pinning system should not pin the entity to the pin bucket associated with the respective data center, and should allow the scheduled replication to take place at the particular effective replication time.

Based on determining that the time associated with the request is within the pre-defined time limitation, the pinning system pins the entity to pin bucket 110 for a particular period of time. For example, the pinning system generates an entry, in pin bucket 110, that includes an identifier of the entity, and an indicator of the particular period of time that the entity is pinned to pin bucket 110. In some instances, the particular period of time is represented by an effective pinning termination time which identifies the time when the pinning of the entity to pin bucket 110 is to be lifted. As a result of the pinning of the entity to pin bucket 110 of data center 102, the data requests that are associated with the data related to the entity (or to the entity and a service) and that are received during the pinning time are serviced from data center 102.

At an effective replication time associated with entity bucket 106, the pinning system accesses pin bucket 110 and determines that an entity identifier (e.g., Entity 123) associated with entity bucket 106 is included in pin bucket 110. Identifiers of other entities may also be associated with entity bucket 106. The pinning system causes a replication of the data related to the entities associated with entity bucket 106, except the data related to Entity 123 (which is pinned to pin bucket 110), from data center 102 to data center 104. At data center 104, the entities associated with the replicated data are assigned, by the pinning system, to bucket 112 of data center 104. When the pinning of Entity 123 to pin bucket 110 expires, the pinning system replicates the data related to Entity 123 to data center 104, and assigns Entity 123 to entity bucket 112.

An example method and system for pinning the data associated with an entity to a data center for a period of time may be implemented in the context of the client-server system illustrated in FIG. 1B. As illustrated in FIG. 1B, the pinning system 200 is part of the social networking system 120. As shown in FIG. 1B, the social networking system 120 is generally based on a three-tiered architecture, consisting of a front-end layer, application logic layer, and data layer. As is understood by skilled artisans in the relevant computer and Internet-related arts, each module or engine shown in FIG. 1B represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1B. However, a skilled artisan will readily recognize that various additional functional modules and engines may be used with a social networking system, such as that illustrated in FIG. 1B, to facilitate additional functionality that is not specifically described herein. Furthermore, the various functional modules and engines depicted in FIG. 1B may reside on a single server computer, or may be distributed across several server computers in various arrangements. Moreover, although depicted in FIG. 1B as a three-tiered architecture, the inventive subject matter is by no means limited to such architecture.

As shown in FIG. 1B, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 142 to exchange information with the social networking system 120. Each of the client devices 150 may comprise a computing device that includes at least a display and communication capabilities with the network 142 to access the social networking system 120. The client devices 150 may comprise, but are not limited to, remote devices, work stations, computers, general purpose computers. Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1B, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the SNS may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For example, an ad serving engine showing ads to users may be implemented with one or more application server modules 124. According to another example, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1B, social networking system 120 may include the pinning system 200, which is described in more detail below.

Further, as shown in FIG. 1B, a data processing module 134 may be used with a variety of applications, services, and features of the social networking system 120. The data processing module 134 may periodically access one or more of the databases 128, 130, 132, or 136, process (e.g., execute batch process jobs to analyze or mine) profile data, social graph data, member activity and behavior data, or entity and pinning data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

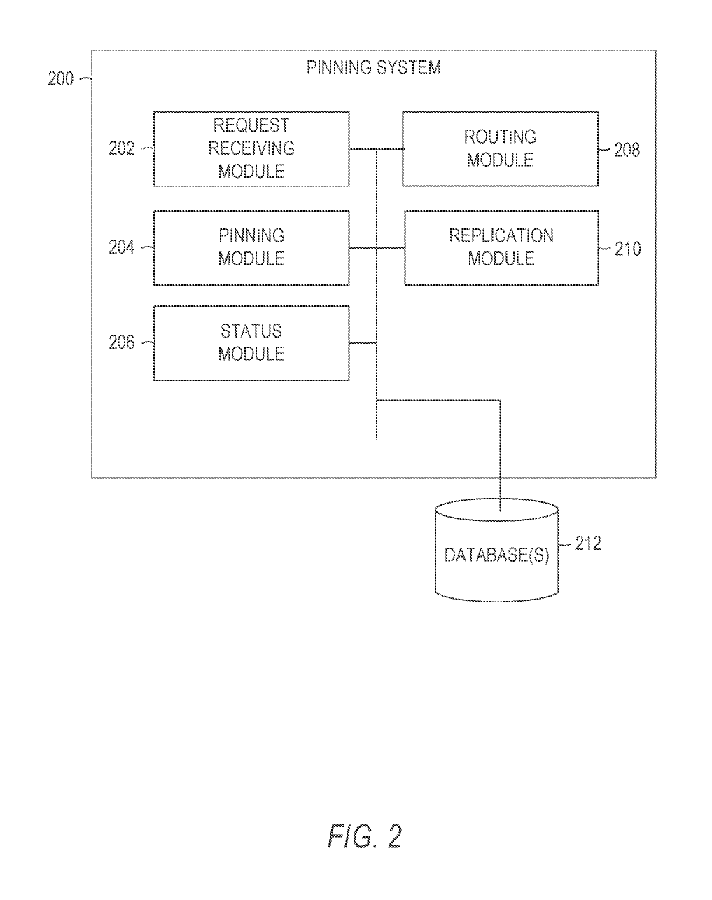

FIG. 2 is a block diagram illustrating components of the pinning system 200, according to some example embodiments. As shown in FIG. 2, the pinning system 200 includes a request receiving module 202, a pinning module 204, a status module 206, a routing module 208, and a replication module 210, all configured to communicate with each other (e.g., via a bus, shared memory, or a switch).

According to some example embodiments, the request receiving module 202 receives a request to initiate an operation that uses data associated with an entity. The request may be received from a client device. The data associated with the entity is stored at one or more data centers of a plurality of data centers.

The pinning module 204, based on the request to initiate the operation, pins the entity to a first data center of the plurality of data centers for a period of time. The pinning results in a suspension of a scheduled routing of data requests associated with the entity to a second data center of the plurality of data centers.

In some example embodiments, the request to initiate the operation includes a write request to provide or update the data associated with the entity at a record of a database. The pinning module 204 may determine a type of data being provided or updated (e.g., member registration data, payment data, subscription data, etc.) based on the write request, determining a type of data being updated. The pinning of the entity to the first data center for the period of time may be further based on the type of data.

In various example embodiments, the request to initiate the operation includes a read request to read the data associated with the entity from a record of a database. The pinning module 204 may determine a type of data being read based on the read request. The pinning of the entity to the first data center for the period of time may be further based on the type of data.

In certain example embodiments, the request to initiate the operation includes a request to use an online service (e.g., a subscription service, a payment service, etc.). The pinning module 204 may determine a type of online service based on the request to use the online service. The pinning of the entity to the first data center for the period of time may be further based on the type of service. For example, if the pinning module 204 determines that the received request is a request to use a subscription service (e.g., the user of a client device is attempting to subscribe online to receive job descriptions that match the user's profile and that are related to the entity), the pinning module 204 pins the entity to the first data center for a period of time to allow the operations included in the use of the subscription service to be completed.

The status module 206 determines a status of the operation that uses the data associated with the entity. The status of the operation may indicate that the operation is completed, or that the operation is not completed. The status module 206, in some instances, is a service that tracks (e.g., monitors) the completion of various operations that use data associated with various entities.

The routing module 208, based on a determination that the operation is completed, updates data pertaining to the scheduled routing in a routing record that associates the entity with the second data center of the plurality of data centers. The updating of the data pertaining to the scheduled routing in the routing record may include modifying an effective routing time that indicates when to start routing data requests for the data related to the entity to the second data center.

In some example embodiments, the routing module 208 identifies, based on the request for data access to data associated with the entity, the second data center as a location from which to service the request for data access to the data associated with the entity. For instance, the routing module 208 accesses, based on an entity identifier included in the request for data access, a database record (e.g., the routing record) that is associated with the entity and that includes an identifier of the second data center. The identifier of the second data center may indicate the location from which to service the requests for data access to the data associated with the entity. In some instances, the database record includes, in addition to the data center identifier of the second data center designated as the location from which to service requests for data associated with the entity, an effective time representing a time to start servicing the requests for data associated with the entity.

The replication module 210 causes a replication of the data associated with the entity from the first data center to the second data center. The causing of the replication may be based on the determination that the operation that uses the data associated with the entity is completed. In some example embodiments, the causing of the replication of data includes issuing a command to start replicating the data associated with the entity from a first record at the first data center to a second record at the second data center. In some example embodiments, the causing of the replication includes associating an entity identifier of the entity with an entity bucket stored at the second data center.

To perform one or more of its functionalities, the pinning system 200 may communicate with one or more other systems. For example, an integration system may integrate the pinning system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 212 (e.g., database 128, 130, 132, or 136).

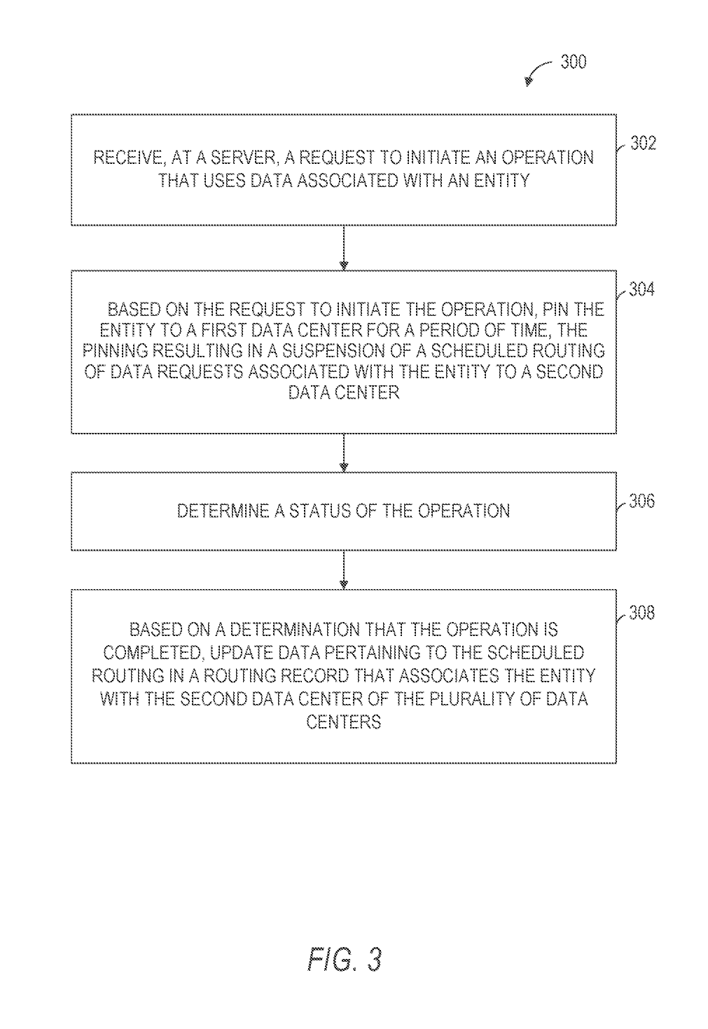

FIGS. 3-8 are flowcharts illustrating a method for pinning the data associated with an entity to a data center for a period of time, according to some example embodiments. Operations in the method 300 illustrated in FIG. 3 may be performed using modules described above with respect to FIG. 2. As shown in FIG. 3, method 300 may include one or more of method operations 302, 304, 306, and 308, according to some example embodiments.

At operation 302, the request receiving module 202 receives a request to initiate an operation that uses data associated with an entity. The request may be received from a client device. The data associated with the entity is stored at one or more data centers of a plurality of data centers.

In some example embodiments, the operation is included in a group of operations associated with a transaction. In various example embodiments, the operation is included (e.g., is a first operation) in a sequence of operations associated with the transaction. For example, receiving the request to initiate the operation includes receiving an indicator of a selection of a user interface element (e.g., a button), by the user, to proceed to paying for an online service or product (e.g., an item).

At operation 304, the pinning module 204 pins the entity to a first data center of the plurality of data centers for a period of time. The pinning may be based on the request to initiate the operation. The pinning results in a suspension of a scheduled routing of data requests associated with the entity to a second data center of the plurality of data centers.

In some example embodiments, the pinning module 204 determines a type of the operation that uses the data associated with the entity. The pinning of the entity to the first data center for the period of time may be further based on the type of the operation.

In some example embodiments, the request to initiate the operation includes a write request to provide or update the data associated with the entity at a record of a database. The pinning module 204 may determine a type of data being provided or updated (e.g., member registration data, payment data, subscription data, etc.) based on the write request, determining a type of data being updated. The pinning of the entity to the first data center for the period of time may be further based on the type of data.

In various example embodiments, the request to initiate the operation includes a read request to read the data associated with the entity from a record of a database. The pinning module 204 may determine a type of data being read based on the read request. The pinning of the entity to the first data center for the period of time may be further based on the type of data.

In certain example embodiments, the request to initiate the operation includes a request to use an online service (e.g., a subscription service, a payment service, etc.). The pinning module 204 may determine a type of online service based on the request to use the online service. The pinning of the entity to the first data center for the period of time may be further based on the type of service. For example, if the pinning module 204 determines that the received request is a request to use a subscription service (e.g., the user of a client device is attempting to subscribe online to receive job descriptions that match the user's profile and that are related to the entity), the pinning module 204 pins the entity to the first data center for a period of time to allow the operations included in the use of the subscription service to be completed.

At operation 306, the status module 206 determines a status of the operation that uses the data associated with the entity. The status of the operation may indicate that the operation is completed, or that the operation is not completed.

At operation 308, the routing module 208 updates data pertaining to the scheduled routing in a routing record that associates the entity with the second data center of the plurality of data centers. The updating may be based on a determination that the operation is completed. The updating may include modifying (e.g., changing, editing, etc.) the effective time of the scheduled routing of the data requests associated with the entity to the second data center to a time after the operation is determined to be completed.

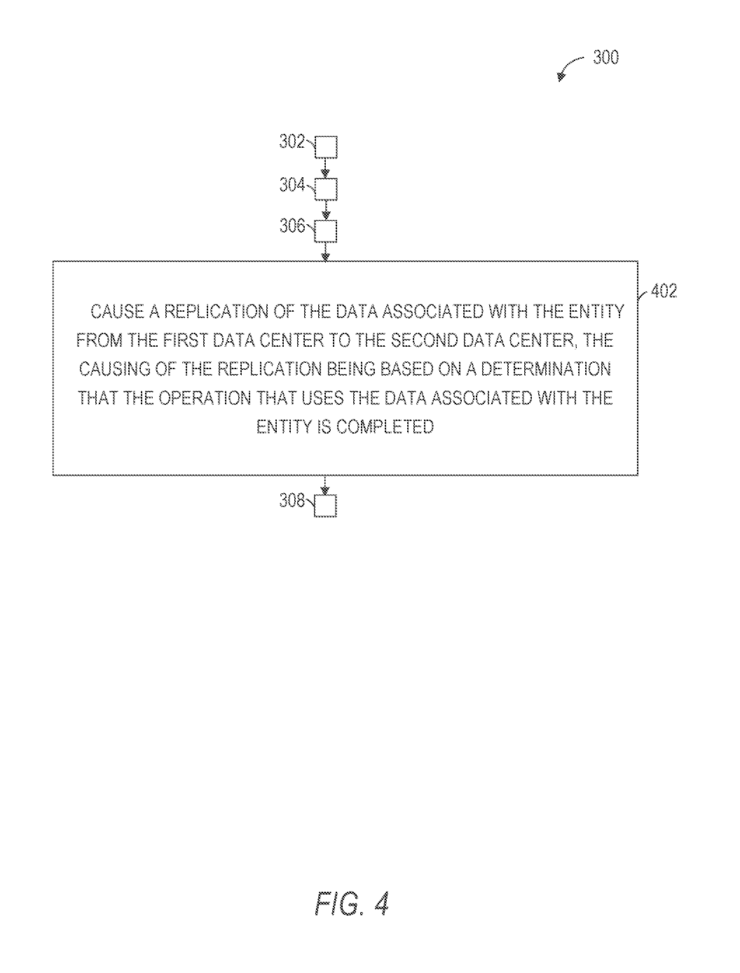

Further details with respect to the method operations of the method 300 are described below with respect to FIGS. 4-8.

As shown in FIG. 4, the method 300 may include operation 402, according to some example embodiments. Operation 402 may be performed after operation 306, in which the status module 206 determines the status of the operation that uses the data associated with the entity.

At operation 402, the replication module causes a replication of the data associated with the entity from the first data center (e.g., a database record at the first data center) to the second data center (e.g., a database record at the second data center). The causing of the replication of the data is based on the determination that the operation that uses the data associated with the entity is completed. In some example embodiments, the causing of the replication of the data includes associating an entity identifier of the entity with an entity bucket stored at the second data center.

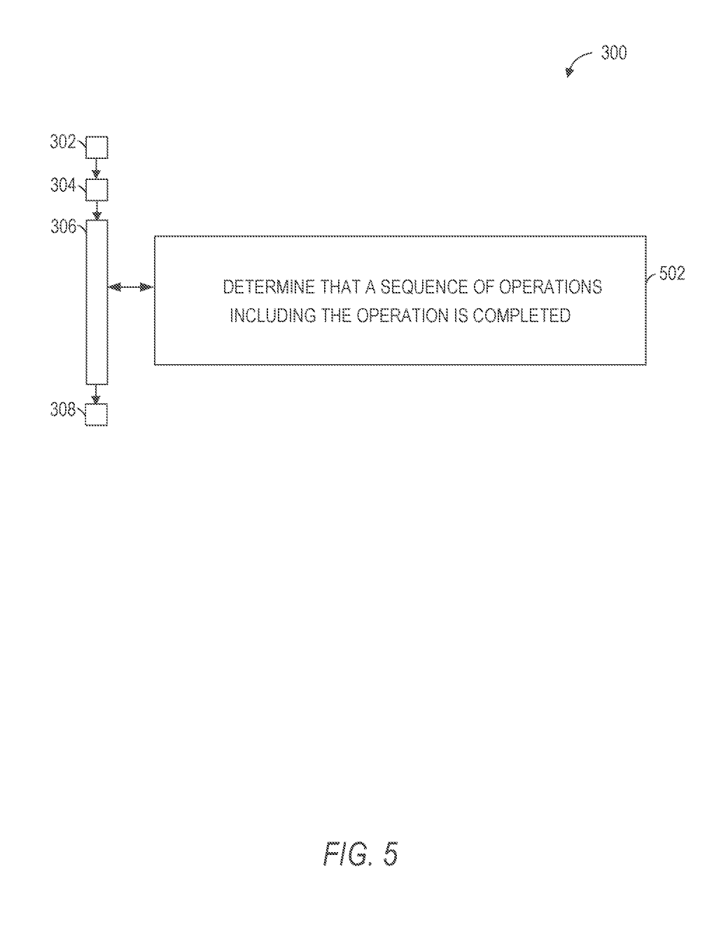

As shown in FIG. 5, the method 300 may include operation 502, according to some example embodiments. Operation 502 may be performed as part (e.g., a precursor task, a subroutine, or a portion) of operation 306 of FIG. 3, in which the status module 206 determines the status of the operation that uses the data associated with the entity.

In some example embodiments, the operation is included in a sequence of operations associated with a transaction. The sequence of operations, in some instances, may be a sequence of payment-related steps provided by an online payment service (e.g., an application) associated with a social networking service. At operation 502, the status module 206 determines that the sequence of operations including the operation is completed.

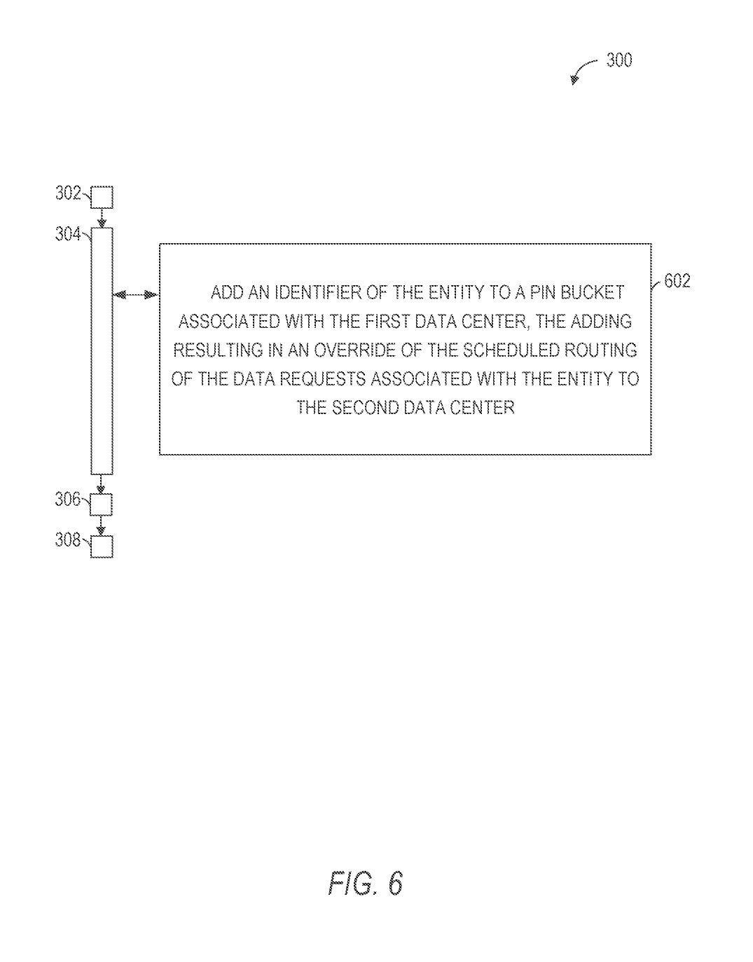

As shown in FIG. 6, the method 300 may include operation 602, according to some example embodiments. Operation 602 may be performed as part (e.g., a precursor task, a subroutine, or a portion) of operation 304 of FIG. 3, in which the pinning module 204 pins the entity to a first data center of the plurality of data centers for a period of time.

At operation 602, the pinning module 204 adds an identifier of the entity to a pin bucket associated with the first data center. The pin bucket may be a database record that stores identifiers of one or more entities associated with data that is being used in responding to one or more requests to initiate one or more operations. The adding of the identifier of the entity to the pin bucket associated with the first data center results in an override of the scheduled routing of the data requests associated with the entity to the second data center.

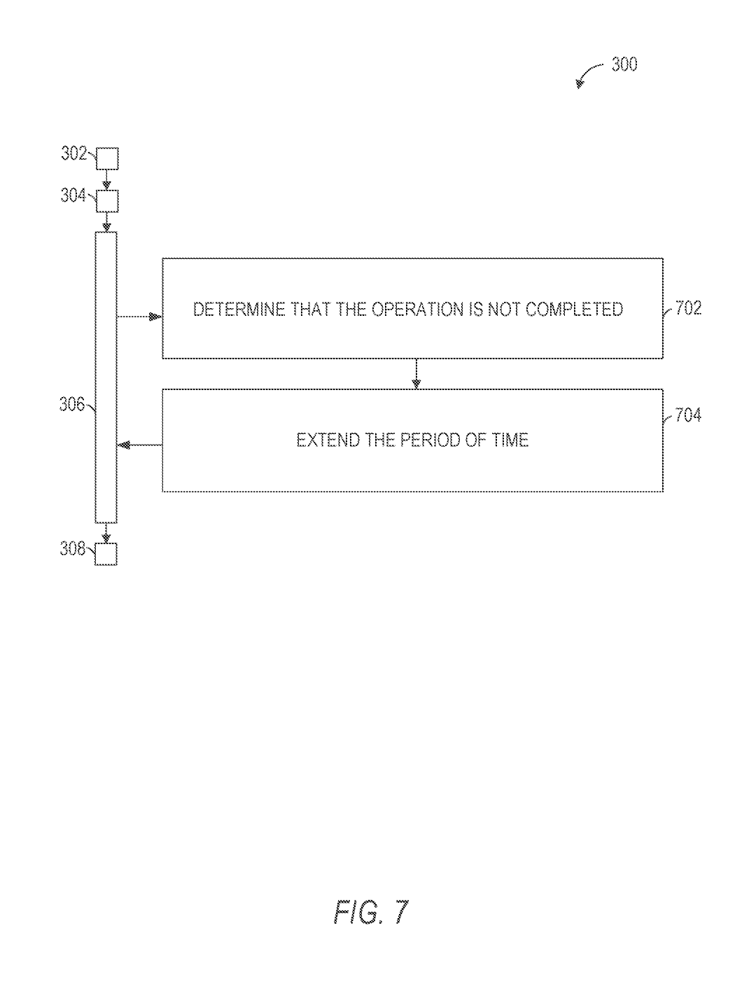

As shown in FIG. 7, the method 300 may include operations 702 or 704, according to some example embodiments. Operation 702 may be performed as part (e.g., a precursor task, a subroutine, or a portion) of operation 306 of FIG. 3, in which the status module 206 determines a status of the operation that uses the data associated with the entity.

At operation 702, the status module 206 determines that the operation that uses the data associated with the entity is not completed. The determining that the operation is not completed may be based on the status module 206 transmitting a query to an operation monitoring service regarding the status of the operation, and receiving a query reply, from the operation monitoring service, that indicates that the operation is not completed.

At operation 704, the status module 206 extends the period of time (e.g., modifies or increases a default period of time associated with the pinning) at a database record that identifies the duration of the pinning. The extending of the period of time results in an extended period of time. In some example embodiments, the status module 206, after an expiration of the extended period of time, determines that the operation that uses the data associated with the entity is completed.

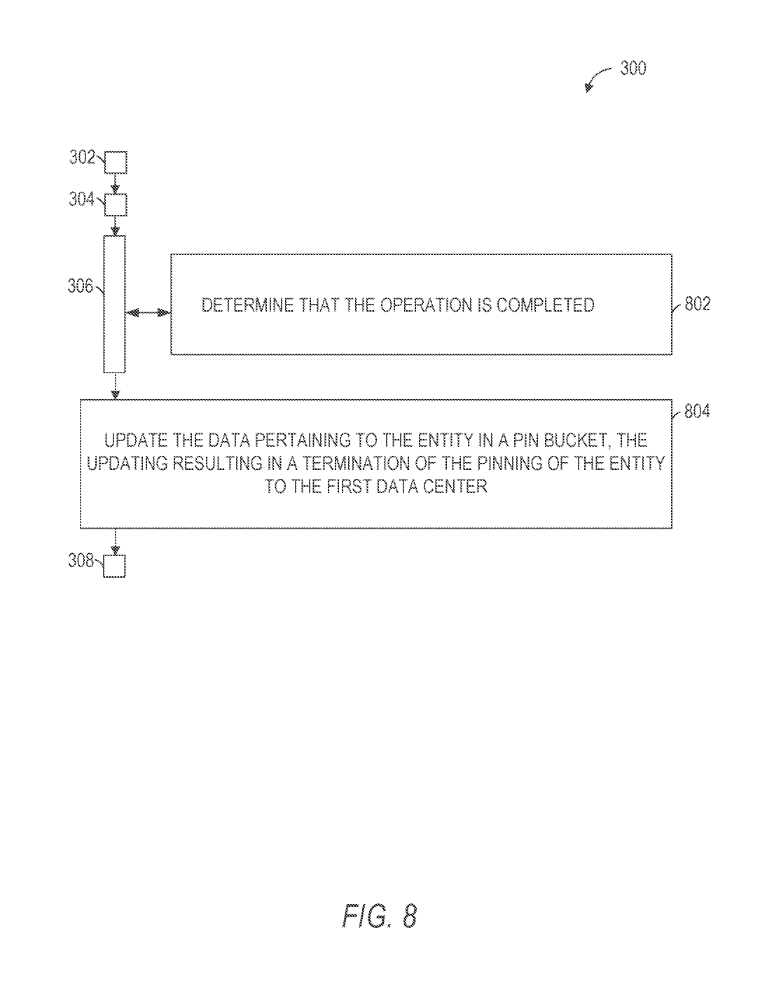

As shown in FIG. 8, the method 300 may include operations 802 or 804, according to some example embodiments. Operation 802 may be performed as part (e.g., a precursor task, a subroutine, or a portion) of operation 306 of FIG. 3, in which the status module 206 determines a status of the operation that uses the data associated with the entity.

At operation 802, the status module 206 determines that the operation that uses the data associated with the entity is completed. The determining that the operation is completed may be based on the status module 206 transmitting a query to an operation monitoring service regarding the status of the operation, and receiving a query reply, from the operation monitoring service, that indicates that the operation is completed.

At operation 804, the pinning module 204 updates the data pertaining to the entity in a pin bucket associated with the first data center. The updating of the data pertaining to the entity in the pin bucket associated with the first data center may result in a termination of the pinning of the entity to the first data center.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

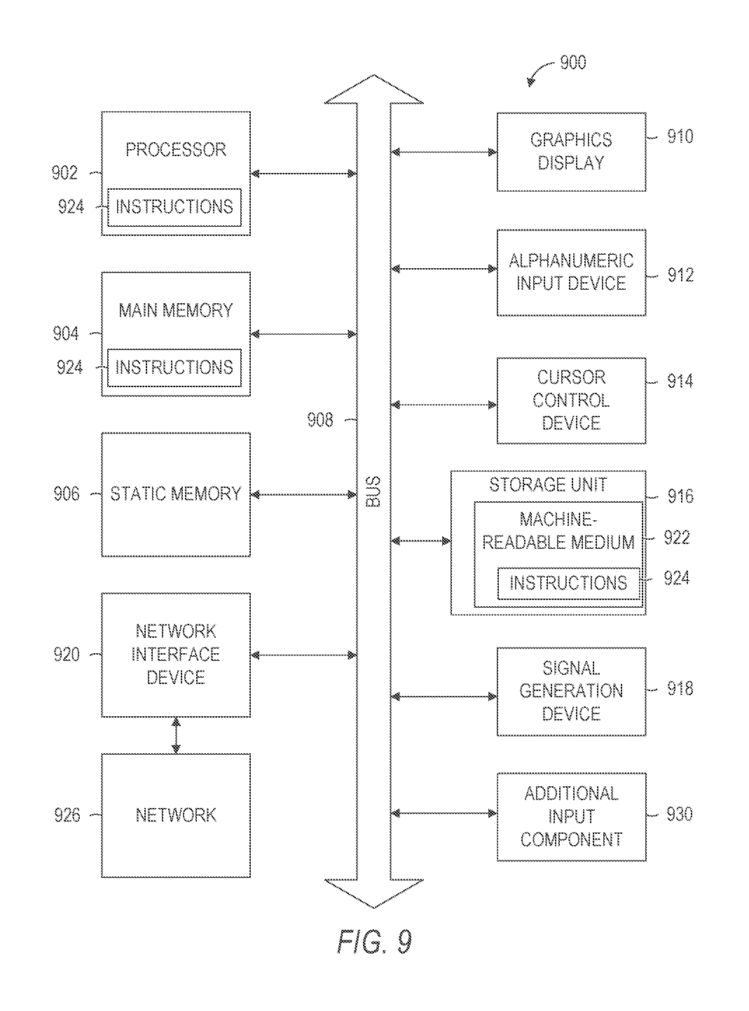

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 926 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, at a server, a request to initiate an operation that uses data associated with an entity, the request being from a client device, the data associated with the entity being stored at one or more data centers of a plurality of data centers;
based on the request to initiate the operation, pinning, using one or more hardware processors, the entity to a first data center of the plurality of data centers for a period of time, the pinning resulting in a suspension of a scheduled routing of data requests associated with the entity to a second data center of the plurality of data centers;
determining a status of the operation that uses the data associated with the entity; and
based on a determination that the operation is completed, updating data pertaining to the scheduled routing in a routing record that associates the entity with the second data center of the plurality of data centers.

2. The method of claim 1, further comprising:
based on the request to initiate the operation, determining a type of the operation that uses the data associated with the entity,
wherein the pinning of the entity to the first data center for the period of time is further based on the type of operation.

3. The method of claim 1, further comprising:
causing a replication of the data associated with the entity from the first data center to the second data center, the causing of the replication being based on the determination that the operation that uses the data associated with the entity is completed.

4. The method of claim 1, wherein the operation is included in a group of operations associated with a transaction.

5. The method of claim 1, wherein the operation is included in a sequence of operations associated with a transaction.

6. The method of claim 5, wherein the determining of the status of the operation includes determining that the sequence of operations including the operation is completed.

7. The method of claim 1, wherein the request to initiate the operation includes a write request to update the data associated with the entity at a record of a database.

8. The method of claim 7, further comprising:
based on the write request, determining a type of data being updated,
wherein the pinning of the entity to the first data center for the period of time is further based on the type of data.

9. The method of claim 1, wherein the request to initiate the operation includes a read request to read the data associated with the entity from a record of a database.

10. The method of claim 9, further comprising:
based on the read request, determining a type of data being read,
wherein the pinning of the entity to the first data center for the period of time is further based on the type of data.

11. The method of claim 1, wherein the pinning of the entity to the first data center includes:
adding an identifier of the entity to a pin bucket associated with the first data center, the pin bucket being a record that stores identifiers of one or more entities associated with data used in responding to one or more requests to initiate one or more operations, the adding resulting in an override of the scheduled routing of the data requests associated with the entity to the second data center.

12. The method of claim 1, wherein the determining of the status of the operation includes:
determining that the operation that uses the data associated with the entity is not completed; and
extending the period of time, the extending resulting in an extended period of time.

13. The method of claim 12, further comprising:
after an expiration of the extended period of time, determining that the operation that uses the data associated with the entity is completed.

14. The method of claim 1, wherein the determining of the status of the operation includes:
determining that the operation that uses the data associated with the entity is completed,
the method further comprising:
updating the data pertaining to the entity in a pin bucket, the updating resulting in a termination of the pinning of the entity to the first data center.

15. A system comprising:
one or more hardware processors; and
a machine-readable medium for storing instructions that, when executed by the one or more hardware processors, cause the one or more hardware processors to perform operations comprising:
receiving, at a server, a request to initiate an operation that uses data associated with an entity, the request being from a client device, the data associated with the entity being stored at one or more data centers of a plurality of data centers;
based on the request to initiate the operation, pinning the entity to a first data center of the plurality of data centers for a period of time, the pinning resulting in a suspension of a scheduled routing of data requests associated with the entity to a second data center of the plurality of data centers;
determining a status of the operation that uses the data associated with the entity; and
based on a determination that the operation is completed, updating data pertaining to the scheduled routing in a routing record that associates the entity with the second data center of the plurality of data centers.

16. The system of claim 15, wherein the operations further comprise:
based on the request to initiate the operation, determining a type of the operation that uses the data associated with the entity,
wherein the pinning of the entity to the first data center for the period of time is further based on the type of operation.

17. The system of claim 15, wherein the operations further comprise:
causing a replication of the data associated with the entity from the first data center to the second data center, the causing of the replication being based on the determination that the operation that uses the data associated with the entity is completed.

18. The system of claim 15, wherein the pinning of the entity to the first data center includes:
adding an identifier of the entity to a pin bucket associated with the first data center, the pin bucket being a record that stores identifiers of one or more entities associated with data used in responding to one or more requests to initiate one or more operations, the adding resulting in an override of the scheduled routing of the data requests associated with the entity to the second data center.

19. The system of claim 15, wherein the determining of the status of the operation includes:
determining that the operation that uses the data associated with the entity is completed,
the method further comprising:
updating the data pertaining to the entity in a pin bucket, the updating resulting in a termination of the pinning of the entity to the first data center.

20. A non-transitory machine-readable storage medium comprising instructions that, when executed by one or more hardware processors of a machine, cause the one or more hardware processors to perform operations comprising:
receiving, at a server, a request to initiate an operation that uses data associated with an entity, the request being from a client device, the data associated with the entity being stored at one or more data centers of a plurality of data centers,
based on the request to initiate the operation, pinning the entity to a first data center of the plurality of data centers for a period of time, the pinning resulting in a suspension of a scheduled routing of data requests associated with the entity to a second data center of the plurality of data centers,
determining a status of the operation that uses the data associated with the entity; and
based on a determination that the operation is completed, updating data pertaining to the scheduled routing in a routing record that associates the entity with the second data center of the plurality of data centers.
